(19) United States
(12) Patent Application Publication
(10) Pub. No.: US 2005/0271573 A1
(43) Pub. Date: Dec. 8, 2005

(54) Fibrous fullerene crystal and process for producing same

(76) Inventor: Tetsuro Yohsii, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/142,273

(22) Filed: Jun. 2, 2005

(30) Foreign Application Priority Data
Jun. 2, 2004 (JP) 2004-165085

(51) Int. Cl. B82B 1/00

(52) U.S. Cl. 423/445 B

(57) ABSTRACT

There are disclosed a fibrous fullerene crystal comprising at least 80 mole % of fullerene C₇₀, and having a diameter of at most 500 nm and an aspect ratio of at least 2000; an aggregate comprising at least 1% by volume of the above fibrous fullerene crystal, and having a void ratio of at most 99%; and a process for producing a fibrous fullerene crystal comprising the step of bringing an alcohol into contact with a solution of fullerene C₇₀ which amounts to at least 50 mole % of its saturation solubility and which is dissolved in a solvent composed of a single phase containing at least 50 mole % of pyridine so as to form an interface therebetween, and mixing the solution with the alcohol by counter diffusion. The fibrous fullerene crystal is applicable to purposes of use such as catalyst carriers for fuel cells, wiring materials, micromachine shaft materials and so forth.

### BACKGROUND OF THE INVENTION

1. Field of the Invention

The present invention relates to a fibrous fullerene crystal, particularly a fibrous fullerene crystal which contains at least 80 mole % of fullerene C₇₀, an aggregate which contains at least 1% by volume of said fibrous fullerene crystal, and a process for producing a fibrous fullerene crystal.

2. Description of the Related Arts

Diamond and graphite are known as a substance which is synthesized from a carbon element alone. In recent years there have been newly found spherical molecules consisting of 60 or 70 or more carbon atoms, and research is being made on the physical properties and application of the above-mentioned molecules. These molecules, which are called fullerene, are each in the form of soccer ball (for instance, refer to H. W. Kroto et al, Nature 318 (1985) 162). There have been found not only the fullerene consisting of 60 carbon atoms, but also fullerenes each consisting of 70, 72, 76, 84 or more carbon atoms.

As a method of obtaining such a fullerene crystal, a variety of methods are known, including, for instance, a reported method in which isopropyl alcohol is added to a solution of fullerene C₆₀ in toluene to obtain an acicular single crystal of fullerene measuring 200 nm to 2 mm in diameter and 0.15 mm to 5 mm in length (for instance, refer to K. Miyazawa et al, J. Mater. Res., Vol. 17, No. 1, 83 (2002)).

In addition, there is reported that an acicular single crystal of fullerene C₇₀ measuring 795 to 1760 nm in diameter and 90 μm or longer in length is obtained by adding isopropyl alcohol to a solution of fullerene C₇₀ in toluene (for instance, refer to K. Miyazawa et al, J. Am. Ceram. Soc., 85 [5] 1297-99 (2002)).

Moreover there is reported that a whisker-like crystal of fullerene C₆₀ or C₇₀ can be formed by dissolving fullerene in toluene or xylene, bringing the resultant solution into contact with an alcohol which is a poor solvent for the fullerene, and mixing those by means of diffusion only (for instance, refer to Japanese Patent Application Laid-Open No. 1600/2003 (Heisei 15)).

However, the fibrous fullerene which is disclosed in Japanese Patent Application Laid-Open No. 1600/2003 (Heisei 15) has an aspect ratio (ratio of length/outside diameter) of up to 300, approximately, and specifically there are disclosed nothing more than a fullerene C₆₀ measuring several hundred nm in diameter and several ten μm in length (aspect ratio of 100) and a fullerene C₇₀ measuring about 800 nm in minimum diameter and 90 μm in length (aspect ratio of 112).

In addition, Kunichi Miyazawa, Unearthing strategy for advanced industries by using nanofiber technology, February, 2004, CMC Publication discloses a nanowhisker of fullerene C₇₀ having a diameter of about 200 nm, but fails to state the fiber length thereof. As mentioned above, it has been extremely difficult to prepare a fiber having a small diameter and a great length from fullerene C₇₀.

### SUMMARY OF THE INVENTION

In the light of the above-described circumstances, it is an object of the present invention is to provide a fibrous fullerene crystal which comprises at least 80 mole % of fullerene C₇₀, and which has a small diameter and a great fiber length, specifically a fiber diameter of at most 500 nm and an aspect ratio of at least 2000 and at the same time, provide a process for an efficient production of the above-mentioned fibrous fullerene crystal.

Other objects of the present invention will become obvious from the text of the specification hereinafter disclosed.

In order to achieve the above-mentioned object, intensive extensive research and investigation were accumulated by the present inventors. As a result, it has been discovered that a fibrous fullerene crystal which comprises at least 80 mole % of fullerene C₇₀ having a small diameter and a great fiber length is obtainable by a method in which fullerene C₇₀ is dissolved in a specific solvent, the resultant solution is brought into contact with an alcohol so as to form an interface therebetween, and the foregoing solution/alcohol are mixed by means of counter diffusion. It being so, the present invention has been accomplished by the foregoing findings and information.

Specifically the present invention provides the following.
1. A fibrous fullerene crystal which comprises at least 80 mole % of fullerene C₇₀, and which has a diameter of at most 500 nm and an aspect ratio of at least 2000;
2. An aggregate which comprises at least 1% by volume of the fibrous fullerene crystal as set forth in the preceding item 1, and which has a void ratio of at most 99%;
3. A process for producing a fibrous fullerene crystal comprising the step of bringing an alcohol into contact with a solution of fullerene C₇₀ which amounts to at least 50 mole % of its saturation solubility and which is dissolved in a solvent composed of a single phase containing at least 50 mole % of pyridine so as to form an interface therebetween, and mixing said solution with said alcohol by means of counter diffusion;
4. The process for producing a fibrous fullerene crystal as set forth in the preceding item 3, wherein the alcohol contains isopropyl alcohol in a content of at least 50 mole %;
5. The process for producing a fibrous fullerene crystal as set forth in the preceding item 3, which further comprises the step of irradiating said solution and said alcohol with light having a wavelength of 250 to 550 nm at the time of the counter diffusion;
6. The process for producing a fibrous fullerene crystal as set forth in any of the preceding item 3, wherein the counter diffusion is effected at a temperature of 25° C. or lower;
7. The process for producing a fibrous fullerene crystal as set forth in the preceding item 3, which further comprises the step of heat treating the resultant fibrous fullerene crystal at a temperature of 300° C. or lower;
8. The process for producing a fibrous fullerene crystal as set forth in the preceding item 3, which further comprises the step of irradiating the resultant fibrous fullerene crystal with light having a wavelength of 250 to 550 nm;
9. The process for producing a fibrous fullerene crystal as set forth in the preceding item 3, wherein the fibrous fullerene crystal has a fiber diameter of at most 500 nm and an aspect ratio of at least 2000; and
10. The process for producing a fibrous fullerene crystal as set forth in the preceding item 3, which further comprises the step of heat treating the resultant fibrous fullerene crystal at a temperature in the range of 700 to 950° C. in an atmosphere of reduced pressure of at most 13 mPa.

### BRIEF DESCRIPTION OF THE DRAWINGS

FIG. 1 is a scanning electron microscope (SEM) micrograph of the fibrous fullerene C₇₀ crystal as produced in Example 1; and

FIG. 2 is a scanning electron microscope (SEM) micrograph of the fibrous fullerene C₇₀ crystal as produced in Example 3.

### DESCRIPTION OF PREFERRED EMBODIMENTS

The fibrous fullerene crystal according to the present invention is characterized in that it is a fibrous fullerene crystal which comprises at least 80 mole % of fullerene C₇₀, and which has a fiber diameter of at most 500 nm and an aspect ratio of at least 2000.

When the purity of the fullerene C₇₀ is less than 80 mole %, the fullerene crystal precipitates, thereby making it impossible to obtain a fibrous crystal. As the fibrous fullerene crystal is formed together with a tree-like fullerene crystal, the purity of the fullerene C₇₀ is preferably at least 90 mole % from the point of view of obtaining the fibrous fullerene crystal in high purity.

In addition, when the fiber diameter is at most 500 nm, it is made possible to impart flexibility to the fiber, and in the case where the fiber is made into paper in the form of nonwoven fabric as mentioned hereinafter, it is made possible to obtain flexible paper.

The aspect ratio, which is the quotient obtained by dividing fiber length by fiber diameter, is at least 2000, and the higher the aspect ratio, the better the fullerene crystal. In the case of a high aspect ratio, it is possible to control the ratio by folding or breaking the fibrous fullerene crystal.

The fibrous fullerene crystal according to the present invention can be made into an aggregate, for instance, by making into paper in the form of nonwoven fabric, and alternatively can be made into an aggregate in the form of nonwoven fabric at the time of crystallization depending upon the production process. The fibrous fullerene crystal obtained as an aggregate at the time of crystallization is usually an aggregate which comprises at least 1% by volume of the fibrous fullerene crystal and which has a void ratio of at most 99%. The void ratio, when being at most 99%, leads to capability of favorably maintaining the aggregate without specific limitation on the lower limit of the void ratio.

By controlling the void ratio in the aggregate, it is possible to vary its flexibility, and at the same time to employ the same for a variety of applications in accordance with the void ratio. For instance, the aggregate is used for a filter and the like requiring mechanical strength by controlling the void ratio to about 20 to 50%, for a catalyst carrier by controlling the void ratio to about 30 to 70%, for a filter and the like requiring flexibility by controlling the void ratio to 70% or more, for applications requiring flexibility to the extent of paper by controlling the void ratio to 80% or more and so forth.

In the following, detailed description will be given of processes for the production of fullerene fibers containing the fibrous fullerene crystal according to the present invention.

A solution is obtained by dissolving a highly pure fullerene C₇₀ in a solvent consisting of a single phase containing at least 50 mole % of pyridine (hereinafter referred to as “fullerene solution”). In this case, the purity of the fullerene C₇₀ is required to be at least 80 mole % as is the case with the purity thereof in the fibrous fullerene crystal, and is preferably at least 90 mole %. Moreover, the pyridine-containing solvent comprises indispensably at least 50 mole %, preferably at least 70 mole %, more preferably at least 85 mole %. By rendering the content of pyridine in the above-mentioned solvent to be at least 50 mole %, it is possible to efficiently produce the fibrous fullerene crystal which has a diameter of at most 500 nm and an aspect ratio of at least 2000. Although a tree-like fullerene crystal is formed simultaneously during the course of producing the fibrous fullerene crystal, a content of pyridine in the solvent being at least 70 mole % makes it possible to suppress the formation of the tree-like fullerene crystal, and the content thereof being at least 85 mole % makes it possible to more efficiently suppress the formation of the tree-like fullerene crystal. The use of the solvent being a single phase is intended for effective formation of an interface between the fullerene solution and the alcohol as described hereunder.

The temperature at which the fullerene C₇₀ is dissolved in a pyridine-containing solvent is not specifically limited, but is preferably a temperature higher than a temperature at which the fibrous fullerene crystal is deposited by means of counter diffusion as described hereinafter. A high concentration solution of the fullerene C₇₀ can easily be prepared by dissolving the fullerene C₇₀ at a higher temperature, thereafter preserving the same at a temperature at which the counter diffusion is carried out, and thus depositing supersaturated fullerene C₇₀. The concentration of the fullerene C₇₀ solution is preferably such that at least 50 mole % of the saturation solubility of the fullerene C₇₀ is dissolved in the pyridine-containing solvent at a temperature at which the fibrous fullerene crystal is deposited by means of counter diffusion. By dissolving at least 50 mole % of the saturation solubility of the fullerene C₇₀, it is made possible to efficiently produce the fibrous fullerene crystal. From the above-mentioned viewpoint, the dissolved amount of fullerene C₇₀ is preferably at least 75 mole % of the saturation solubility thereof.

In the next place, an alcohol is allowed to slowly flow in and brought into contact with the resultant fullerene solution so as to form an interface therebetween instead of coming to miscibility between the solution and the alcohol. The fullerene solution and the alcohol are mixed by counter diffusion, whereby a fibrous crystal of fullerene C₇₀ is deposited in the alcohol that is a poor solvent for the fullerene C₇₀.

The alcohol to be used therein is not specifically limited, but an isopropyl alcohol-containing alcohol is preferably used in order to efficiently obtain the fibrous crystal thereof. The content of the isopropyl alcohol is not specifically limited, but is preferably at least 50 mole %, particularly preferably at least 75 mole %.

The temperature at which the fibrous crystal of fullerene C₇₀ is deposited by counter diffusion is preferably 25° C. or lower, more preferably 20° C. or lower, particularly preferably 15° C. or lower. The temperature control is put into practice by controlling the temperatures of the fullerene solution and the alcohol to be added thereto.

Subsequently, the fullerene solution to which the alcohol has been added is allowed to stand for the purpose of growing the fibrous fullerene crystal. The temperature in the above-mentioned procedure is not necessarily the same as but is preferably close to the temperature of the fullerene solution and the alcohol from the standpoint of assuring a high-quality fibrous fullerene crystal without impairing the formation of the crystal, and more specifically, preferably falls within +5% from the temperature of the fullerene solution and the alcohol. In particular, when the temperature in the procedure is 20° C. or lower, a crystal having a small diameter and a high aspect ratio is more prone to be formed, since the crystal growth rate becomes high as compared with the diffusion rate.

Further it is preferable to irradiate the fullerene solution and the alcohol with light having a wavelength of 250 to 550 nm at the time of counter diffusion for the purpose of accelerating the growth of the fibrous fullerene crystal. The irradiating light may be either monochromatic light or polychromatic light, and preferably contains a wavelength in the vicinity of 335 nm.

In addition, it is preferable to subject the resultant fibrous fullerene crystal which has been taken out from the fullerene solution and dried to a heat treatment, since such a treatment enables to remove volatile solvents such as pyridine that are present among the molecules of the fullerene C₇₀ which constitutes the fibrous fullerene crystal. The heat treatment temperature may be properly optionally selected, but from the aspects of substantially preventing decomposition and/or deterioration of the fibrous fullerene crystal that are caused by oxidation, thermal cracking or the like, and on the other hand, of favorably removing volatile solvents such as pyridine, the heat treatment temperature is preferably set in the following manner. That is to say, it is preferably set on 300° C. or lower in an atmosphere of oxygen or in an atmosphere containing oxygen, while in an atmosphere of an inert gal such as nitrogen or in an atmosphere of reduced pressure (for instance, 1.3 mPa that is, 10⁻⁵ Torr) the temperature is preferably set on 450° C. or lower.

Moreover, it is made possible according to the present invention to lower the volume resistivity of the above-described fibrous fullerene crystal by heat treating the fibrous fullerene crystal that has been obtained in the foregoing manner at a temperature in the range of 700 to 950° C. in an atmosphere of reduced pressure (for instance, 13 mPa that is, 10⁻⁴ Torr) for 0.5 to 10 hours, approximately.

Furthermore it is preferable to irradiate the fibrous fullerene crystal that has been obtained in the foregoing manner with light having a wavelength of 250 to 550 nm from the standpoint of assuring a fibrous fullerene crystal having high durability. In this case the irradiating light may be either monochromatic light or polychromatic light, and preferably contains a wavelength in the vicinity of 335 nm.

The fibrous fullerene crystal according to the present invention is obtained in different configurations depending upon the reaction conditions and the like, including a crystal which is grown in the form of fiber, an aggregate in which fibrous fullerene crystal containing fullerene C₇₀ is in the form of nonwoven fabric, and so forth.

In the following, the present invention will be described in more detail with reference to comparative examples and working examples, which however shall never limit the present invention thereto.

### EXAMPLE 1

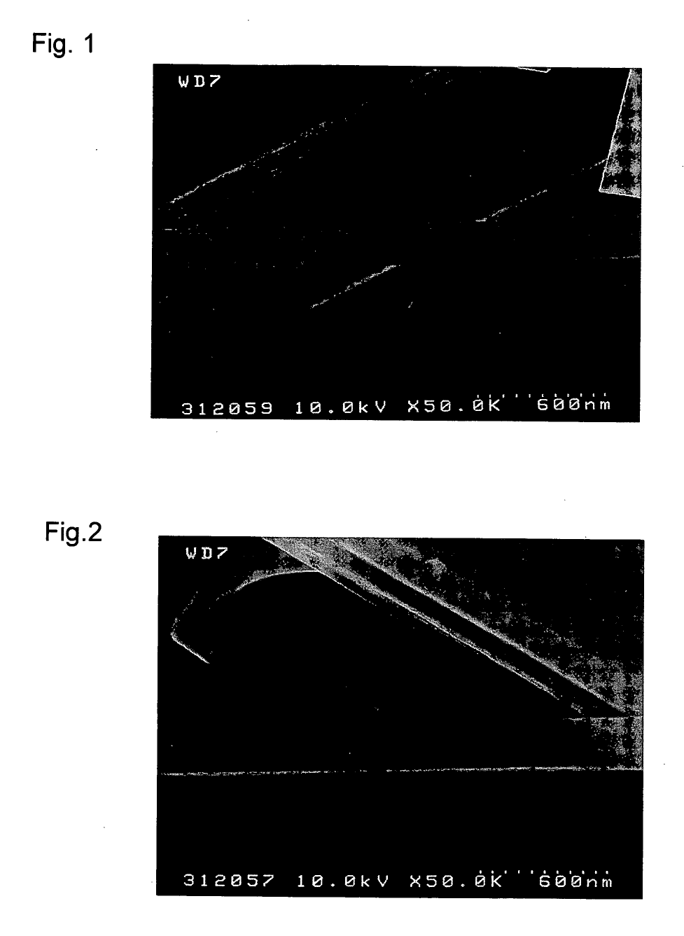

Fullerene C₇₀ (purity of 99%, manufactured by Science Laboratory Co., Ltd.) in an amount of about 0.02 g was dissolved in 20 mL (milliliter) of pyridine at 40° C. to prepare a fullerene solution, and thereafter the solution thus obtained was preserved overnight at 10° C. Then the fullerene solution was filtered to remove insoluble matters, and 2 mL of the resultant filtrate was weighed, placed in a 9 mL vessel, and further preserved overnight at 10° C. 6 mL of isopropyl alcohol which had been preserved at 10° C. separately was allowed to slowly flow in the above-obtained filtrate, and preserved at 10° C. for 60 hours along with the filtrate in a state that the pyridine solution and the isopropyl alcohol maintained an intact interface to form a fibrous crystal. The resultant crystal was filtered and dried at 60° C. to obtain a aggregate of fiber in the form of brown nonwoven fabric. Investigation on the fibers by means of an electron microscope proved as illustrated in FIG. 1 that it was a fibrous crystal having a fiber diameter of about 200 nm and an aspect ratio of about 3000.

### EXAMPLE 2

The procedure in Example 1 was repeated to obtain a fibrous fullerene crystal except that the pyridine solution and the isopropyl alcohol were preserved at 25° C. for 60 hours in a state that they maintained an intact interface. The resultant crystal was filtered and dried at 60° C. to obtain a fibrous fullerene crystal as was the case with Example 1. Investigation on the fiber by means of an electron microscope proved that it was a fibrous crystal having a fiber diameter of about 400 nm and an aspect ratio of about 2000.

### COMPARATIVE EXAMPLE 1

The procedure in Example 1 was repeated as an attempt to produce a fibrous fullerene crystal except that fullerene C₇₀ (purity of 99%, manufactured by Science Laboratory Co., Ltd.) in an amount of about 0.05 g was dissolved in 20 mL of toluene at 40° C. As the result, a precipitate was observed on the bottom in the vessel, resulting in failure to produce a fibrous fullerene crystal.

### COMPARATIVE EXAMPLE 2

The procedure in Example 1 was repeated to obtain a fibrous fullerene crystal except that fullerene C₇₀ (purity of 99%, manufactured by Science Laboratory Co., Ltd.) in an amount of about 0.05 g was dissolved in 20 mL of xylene at 40° C. The fullerene crystal thus formed was filtered and dried at 60° C. in the same manner as in Example 1. As the result, an aggregate of black linear whiskers was obtained. Investigation on the whiskers by means of an electron microscope proved that it was a fibrous crystal having a fiber diameter of about 1 μm and an aspect ratio of about 1000.

### EXAMPLE 3

The procedure in Example 1 was repeated to obtain a fibrous fullerene crystal except that fullerene C₇₀ (purity of 99%, manufactured by Science Laboratory Co., Ltd.) in an amount of about 0.05 g was dissolved in 20 mL of a mixed solution of pyridine and m-xylene at 40° C. at a molar ratio of 1:1. As the result, there was obtained an aggregate of fibers in the form of nonwoven fabric in which brown fibers and black whiskers were mixed. Investigation on the fibers by means of an electron microscope proved as illustrated in FIG. 3 that it was a fibrous crystal having a fiber diameter of about 200 nm and an aspect ratio of about 2000.

### EXAMPLE 4

The filtrate which had been prepared in Example 1 was mixed with the same weight of pyridine, 2 mL of the resultant mixed liquid was weighed and placed in a 9 mL vessel, and preserved overnight at 10° C. 6 mL of isopropyl alcohol which had been preserved at 10° C. separately was allowed to slowly flow in the above-mentioned filtrate. The above-prepared mixed liquid along with the isopropyl alcohol was preserved at 10° C. for 60 hours in a state that the pyridine solution and the isopropyl alcohol maintained an intact interface to form a fibrous crystal. As a result, a thin fibrous crystal and a tree-shaped whisker were formed.

The product thus formed was filtered and dried at 60° C. in the same manner as in Example 1. Thus there was obtained a mixture of brown fibers and tree-shaped whiskers. Investigation on the fibers by means of an electron microscope proved that it was a fibrous crystal having a fiber diameter of about 200 nm and an aspect ratio of about 3000 or more.

### EXAMPLE 5

2 mL of the filtrate which had been prepared in Example 1 was weighed, placed in a 9 mL vessel, and preserved overnight at 10° C. 6 mL of mixed alcohol solution which was composed of isopropyl alcohol and isobutyl alcohol at a molar ratio of 1:1, and which had been preserved at 10° C. separately was allowed to slowly flow in the above-mentioned filtrate, and preserved at 10° C. for 60 hours along with the filtrate in a state that the pyridine solution and the mixed alcohol solution maintained an intact interface to form a fibrous crystal. As a result, a fibrous fullerene crystal and a tree-shaped whisker were formed.

The fullerene crystal thus formed was filtered and dried at 60° C. in the same manner as in Example 1. Thus there was obtained a mixture of brown fibers and tree-shaped whiskers. Investigation on the fibers by means of an electron microscope proved that it was a fibrous crystal having a fiber diameter of about 200 nm and an aspect ratio of about 2000.

### EXAMPLE 6

The aggregate of fibrous fullerene crystal which had been obtained in Example 1 was heat treated at 900° C. for one hour in an atmosphere of reduced pressure of 13 mPa (that is, 10⁻⁴ Torr), and subjected to a measurement of volume resistivity before and after the heat treatment by the method stated hereunder.

Two gold wires each having a diameter of 0.1 mm were placed apart from each other on a slide glass for an optical microscope, and the fibrous fullerene crystal was placed on the gold wires. Further another two gold wires were placed onto the crystal on the internal side of the gold wires which had been previously placed at a distance smaller than that of the previously placed ones. Then another slide glass was placed on the two pairs of gold wires, and the fibrous fullerene crystal and the gold wires were fixed.

In the above-mentioned state, using the external two gold wires as electric current terminal and the internal two gold wires as voltage measuring terminal, the volume resistivity was determined by means of a direct current four terminal method.

Specifically on the basis of the assumption that the fibrous fullerene crystal was in the shape of simple column, an approximate value of the volume resistivity thereof was calculated from the fiber length of the fibrous fullerene crystal and the distance between the foregoing internal gold wires. As a result, the volume resistivity was about 10⁶ Ω·cm before the heat treatment and about 10⁻⁵ Ω·cm after the treatment.

The working effect and industrial applicability of the fibrous fullerene crystal according to the present invention will be summarized in the following. According to the present invention, it is made possible to produce fibrous fullerene C₇₀ having a fineness that is comparable to that of the fibrous fullerene C₆₀ and at the same time, an nonwoven fabric is obtained which is almost same as that using fibrous fullerene C₆₀. It is believed that the electric resistance of the fibrous fullerene C₆₀ is dependent upon the thickness of the fiber, whereas the electric resistance of the fibrous fullerene C₇₀ is independent of the thickness of the fiber, thereby maintaining almost constant electric resistance. Consequently the fibrous fullerene crystal according to the present invention is applicable to purposes of use which make the most of the above-mentioned characteristics. Specifically the fibrous fullerene crystal is applicable to purposes of use such as catalyst carriers for fuel cells, wiring materials, micromachine shaft materials and so forth.

1. A fibrous fullerene crystal which comprises at least 80 mole % of fullerene C₇₀, and which has a diameter of at most 500 nm and an aspect ratio of at least 2000.

2. An aggregate which comprises at least 1% by volume of the fibrous fullerene crystal as set forth in claim 1, and which has a void ratio of at most 99%.

3. A process for producing a fibrous fullerene crystal comprising the step of bringing an alcohol into contact with a solution of fullerene C₇₀ which amounts to at least 50 mole % of its saturation solubility and which is dissolved in a solvent composed of a single phase containing at least 50 mole % of pyridine so as to form an interface therebetween, and mixing said solution with said alcohol by means of counter diffusion.

4. The process for producing a fibrous fullerene crystal according to claim 3, wherein the alcohol contains isopropyl alcohol in a content of at least 50 mole %.

5. The process for producing a fibrous fullerene crystal according to claim 3, which further comprises the step of irradiating said solution and said alcohol with light having a wavelength of 250 to 550 nm at the time of the counter diffusion.

6. The process for producing a fibrous fullerene crystal according to claim 3, wherein the counter diffusion is effected at a temperature of 25° C. or lower.

7. The process for producing a fibrous fullerene crystal according to claim 3, which further comprises the step of heat treating the resultant fibrous fullerene crystal at a temperature of 300° C. or lower.

8. The process for producing a fibrous fullerene crystal according to claim 3, which further comprises the step of irradiating the resultant fibrous fullerene crystal with light having a wavelength of 250 to 550 nm.

9. The process for producing a fibrous fullerene crystal according to claim 3, wherein the fibrous fullerene crystal has a fiber diameter of at most 500 nm and an aspect ratio of at least 2000.

10. The process for producing a fibrous fullerene crystal according to claim 3, which further comprises the step of heat treating the resultant fibrous fullerene crystal at a temperature in the range of 700 to 950° C. in an atmosphere of reduced pressure of at most 13 mPa.
